(19) United States
(12) Patent Application Publication
(10) Pub. No.: US 2019/0055955 A1
(43) Pub. Date: Feb. 21, 2019

(54) Method for Treatment of a Liquid that Contains Chippings

(71) Applicant: Brinkmann Pumpen K.H. Brinkmann GmbH & Co. KG, Werdohl (DE)

(72) Inventor: Dirk Wenderott, Castrop-Rauxel (DE)

(21) Appl. No.: 16/106,216

(22) Filed: Aug. 21, 2018

(30) Foreign Application Priority Data
Aug. 21, 2017 (DE) 102017119019.8

(51) Int. Cl. F04D 29/22; F04D 7/04; F04D 29/18; B02C 18/10; B02C 18/18; B02C 23/36

(52) U.S. Cl. CPC F04D 29/2288; F04D 7/045; B02C 23/36; B02C 18/10; B02C 18/18; F04D 29/181

(57) ABSTRACT

A method for treating a liquid (16) that contains chippings in a collecting basin (10), in which the liquid (16) is sucked from the bottom (12) of the collecting basin (10) by a chopper (18, 18′) that is immersed in the liquid and has a rotating cutting wheel (32), and the liquid is directly recirculated into the collecting basin when the chippings have been chopped by the chopper.

The invention relates to a method for treatment of a liquid that contains chippings in a collecting basin.

More particularly, the invention relates to a method for treatment of coolant/lubricant emulsions that are used for cooling and lubricating tools and workpieces in machine tools.

The coolant/lubricant emulsion that drips off from the workpiece and the tool in the machining zone of a machine tool is collected and led into a collecting basin from which it is then sucked off with a coolant/lubricant pump and is then filtered and recirculated to the machining zone. The coolant/lubricant emulsions frequently contain metal chippings that have been formed in the machining process and are then entrained into the collecting basin with the collected liquid.

It has therefore been known to integrate a chopper into the intake port of a coolant/lubricant pump, the chopper having a cutting wheel that is driven by the pump shaft and serves to chop large-sized chippings when they enter into the pump, so that the chippings will not give rise to malfunction in the pump or a piping system connected thereto. Examples of pumps of this type have been described in EP 1 817 501 B1, EP 1 861 624 B1 and EP 3 042 081 A1.

It is an object of the invention to avoid malfunction in systems in which a chipping-containing liquid is collected in a collecting basin and is then pumped off, even in case of a high amount of chippings.

In order to achieve this object, according to the invention, the liquid is sucked from the bottom of the collecting basin by means of a chopper that has a rotating cutting wheel and is immersed in the liquid, and the liquid is directly recirculated into the collecting basin after the chippings have been chopped with the chopper.

Thus, according to the invention, the function of chopping the chippings is separated from the function of pumping off the liquid from the collecting basin. The chopper reduces the content of large-sized chippings in the liquid and thereby relieves the proper suction pump from dealing with the chippings. This has the advantage that malfunction that may occur during the chopping of the chippings, for example due to an excessive load on the chopper, will not immediately compromise the function of the pump, so that the operation of the machine tool can be continued undisturbed. Moreover, the chopping capacity can be adapted to the respective amount of chippings by employing one or more choppers, possibly in addition to the chopper integrated into the pump.

It is another advantage of the invention that the size of the chippings that are recirculated to the tool together with the emulsion does not depend upon the instantaneous displacement of the pump, but is controlled via the chopping power of the chopper pump and via the length of the operation interval of this pump and may for example be limited by means of a mesh at the inlet of the conveyer pump.

The invention further relates to a chopper that is configured for carrying out the method described above.

Optionally, the method according to the invention may also be carried out with a conventional pump having an integrated chopper, by connecting to the pressure side of the pump a valve assembly with which the liquid is optionally recirculated through the filter and then into the machining zone of the machine tool or is returned directly into the collecting basin. In the phases of operation in which no coolant/lubricating emulsion is needed at the tool and the pump would normally be switched off, the pump can be utilized for chopping the chippings “on stock” by means of the chopper. This has also the advantage that in phases, in which no coolant/lubricating emulsion is needed or the liquid in the collecting basin has reached its minimum level, so that no further liquid should be pumped off, the operation of the pump can be continued, so that long off-periods and frequent operations of switching the pump on and off and the problems related therewith can be avoided.

Embodiment examples will now be described in conjunction with the drawings, wherein:

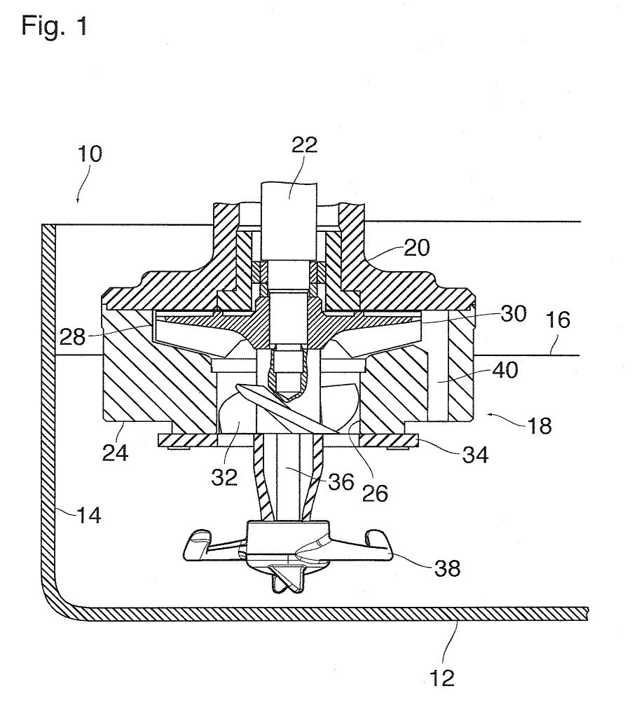

FIG. 1 is an axial sectional view of a chopper in a coolant/lubricating collecting basin of a machine tool; and

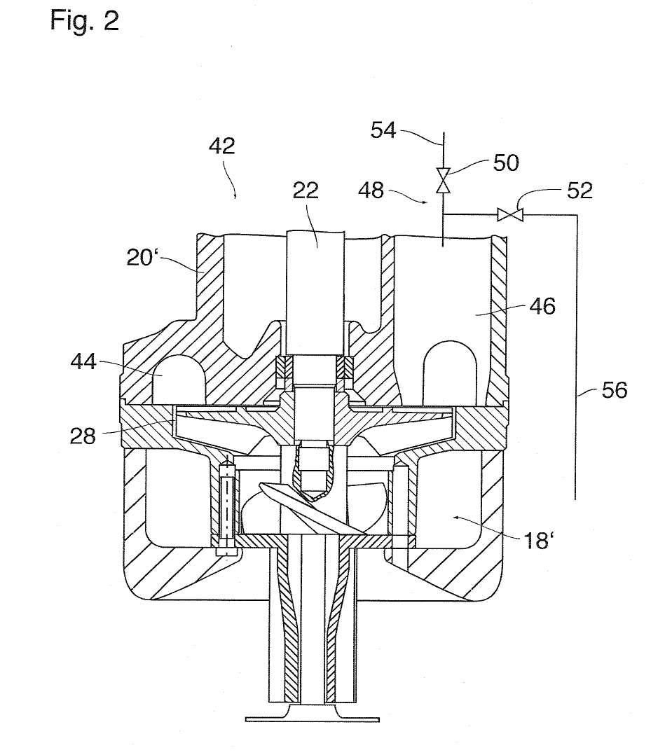

FIG. 2 is a sectional view of a pump having a chopper and a valve assembly, which has only been shown schematically, for carrying out the method according to the invention.

FIG. 1 shows, in a vertical section, an edge zone of a collecting basin 10 which serves for example for collecting coolant/lubricant emulsion in a base of a machine tool that has not been shown. The collecting basin 10 has a bottom 12 and a side wall 14 and is filled with a liquid 16 (coolant/lubricant emulsion) up to a certain level. When the level exceeds an upper limit, the liquid is pumped off with a coolant/lubricant pump that has not been shown, and the liquid is recirculated to the machining zone of the machine tool via a filter.

A chopper 18 has been arranged in the collecting basin 10 independently of the coolant/lubricant pump, the chopper serving for chopping chippings, in particular metal chippings, that have been formed in the machining process performed by the machine tool and have entered the collecting basin 10 together with the liquid 16 and have then settled mainly on the bottom 12 of the basin.

The chopper 18 is mounted on a bottom end of a motor casing 20 which is arranged mainly outside of the collecting basin 10 and accommodates, in its upper part, a motor which has not been shown and drives a motor shaft 22 that is rotatably supported in the casing.

The chopper 18 has a chopper casing 24 which is immersed in the liquid 16 and forms in its lower part a vertical, downwardly opening intake port 26 the upper end of which is connected to a pump chamber 28 that has a larger diameter. The motor shaft 22 carries a radial impeller 30 inside of the pump chamber 18 and a cutting wheel 32 inside of the intake port 26, the cutting wheel being configured as an axial impeller in this example. The intake port 26 is delimited at its lower end by a cutter plate 34 that forms a plurality of intake openings via which the liquid 16 can enter into the intake port 26. Radially extending edges at the lower ends of the wings of the cutting wheel 32 are configured as cutting edges, and radial lands of the cutter plate 34, which lands separate the intake openings from one another, constitute counter-blades which provide a scissors action when the cutting edges of the cutting wheel 32 move past. Optionally, the cutting edges of the cutting wheel 32 or the counter-blades may be toothed.

An extension 36 of the motor shaft 22 projects downwardly from the chopper casing 24 and carries at its lower end a pre-chopper 38 with two radial wings which move closely above the bottom 12 of the collecting basin and are inclined such that they create a liquid flow directed upwardly towards the intake port 26.

An outer peripheral edge of the pump chamber 28 is connected to a plurality of outlet passages 40 distributed on the periphery and opening out into the collecting basin 10 at the bottom side of the chopper casing 24.

When the motor shaft 22 is driven, the pre-chopper 38 sucks-in the chippings that have settled on the bottom 12 of the basin. A part of the chippings that have been sucked in are smashed by the wings of the pre-chopper and enter into the intake port 26 via the intake openings of the cutter plate 34. When entering into the intake port, the chippings are chopped further by the cutting edges of the cutting wheel 32 and the counter-blades cooperating therewith. The radial impeller 30 creates a suction directed upwards and radially outwards, so that the liquid and the finely chopped chippings are entrained into the outlet passages 40 and are then recirculated into the collecting basin 10.

In this way, the chopper 18 reduces the contents of large-sized chippings in the collecting basin 10, so that this basin will mainly contain finely chopped chippings which will not compromise the operation of the suction pump which has not been shown here. Optionally, however, the suction pump may have its own chopper which has basically the same construction as the chopper 18 shown here, so that a larger total chopping capacity is available. In a preferred solution, however, the suction pump is only configured for limiting the size of the chippings passing through, e.g. by means of a mesh.

The pre-chopper 38, the cutting wheel 32 configured as an axial impeller, and the radial impeller 30 create a circulating current in the liquid 16, the current being directed radially inwards towards the axis of the motor shaft 22 near the bottom of the collecting basin 10, so that chippings that have settled on the bottom 12 of the basin in a larger distance from the chopper 18 are conveyed into the intake area of the pre-chopper 38. It is observed that it will be mainly the larger and heavier chippings that are conveyed to the chopper in this way, whereas the smaller chippings which have already been chopped sink to the bottom with a lower speed and therefore remain in suspension in the liquid 16 above the bottom 12 for a longer time.

In a modified embodiment, the radial impeller 30 may be omitted. The liquid will then circulate through the chopper with a lower speed, so that less chippings are supplied to the cutting wheel 32 per time unit, whereas practically the entire torque of the motor is available for cutting the chippings. This embodiment is therefore particularly suited for applications in which the chippings are thick or hard and therefore difficult to cut.

FIG. 2 shows, in an axial section, the lower end of a known suction pump 42 for coolants/lubricants, with a chopper 18′ being integrated into the pump. The chopper 18′ has basically the same construction as the chopper 18 described above, but with the difference that no outlet passages which return directly into the collecting basin are provided at the outer periphery of the pump chamber 28. Instead, the outer periphery of the pump chamber 28 is connected at its top side to a scroll housing 44 that opens into an output passage 46. The motor casing 20 shown in FIG. 1 has been replaced here by a pump casing 20′ accommodating the drive motor of the pump and forming also the output passage 46.

The liquid that has been sucked-in by the pump 42 is supplied into the output passage 46 by the cutting wheel and the radial impeller, while the entrained chippings are chopped with a cutting wheel. A valve assembly 48, which has only been shown schematically in the drawing, is connected to the output passage 46 and contains two blocking valves 50, 52. The blocking valve 50 is arranged in a line 54 that leads to the machining zone of the machine tool via a filter that has not been shown. In contrast, the valve 52 is provided in a branch line 56 which branches off from the line 54 and from the output passage, respectively, and returns into the collecting basin 10. The blocking valves 50, 52 may for example be switched electronically.

In normal pump operation, the blocking valve 50 is open and the blocking valve 52 is closed. However, when no coolant/lubricant emulsion has to be supplied because there is no demand in the machining zone or because the fill level in the collecting basin is too low, the pump operation is continued, and only the blocking valve 50 is closed while the blocking valve 53 is opened, so that the liquid will be recirculated in a closed circuit, with the chippings being chopped by the chopper 18 similarly as in FIG. 1.

What is claimed is:

1. A method for treating a liquid that contains chippings in a collecting, comprising the step of:
sucking the liquid from a bottom of the collecting basin by a chopper that is immersed in the liquid and has a rotating cutting wheel, and
recirculating the liquid directly into the collecting basin when the chippings have been chopped by the chopper.

2. A chopper for carrying out the method according to claim 1, the chopper comprising:
a chopper casing configured to be immersed into the liquid and forming an intake port;
a cutting wheel accommodated in the intake port and which is driven by a motor shaft,
wherein the chopper is constructed to create a suction pressure for sucking the liquid into the intake port;
wherein the chopper casing has at least one outlet passage leading from an output side of the intake port to the intake side of this intake port and configured to recirculate the liquid that has been sucked into the intake port directly back into the collecting basin.

3. The chopper according to claim 2, wherein the cutting wheel is configured as a pump impeller.

4. The chopper according to claim 2,
wherein the chopper casing includes a pump chamber,
wherein the motor shaft is arranged in the pump chamber,
wherein the pump chamber has said at least one outlet passage at an outer periphery thereof,
further comprising a radial impeller accommodated in the pump chamber, and
wherein one or both of the cutting wheel and radial impeller are configured for creating the suction pressure for sucking the liquid into the intake port.

5. The chopper according to claim 2,
wherein the motor shaft, includes an extension which projects from the chopper casing,
further comprising a pre-chopper carried by the extension and which, when the chopper is arranged in the collecting basin, is arranged directly above the bottom of the collecting basin.

6. A suction pump having an integrated chopper and configured for carrying out the method according to claim 1, comprising:
a valve assembly including:
a first blocking valve in a line that leads from an output passage of a pump to a consumer to which the liquid that has been sucked-in is conveyed,
a second blocking valve in a branch line that one of:
branches off from said first line or
extends from the output passage and leads back directly into the collecting basin.

7. The chopper according to claim 3, wherein the cutting wheel is configured as an axial impeller.
